(19) United States
(12) Patent Application Publication
(10) Pub. No.: US 2024/0354589 A1
(43) Pub. Date: Oct. 24, 2024

(54) SYSTEMS AND METHODS FOR QUANTIZED MACHINE LEARNING, FEDERATED LEARNING AND BIDIRECTIONAL NETWORK COMMUNICATION

(71) Applicant: The Regents of the University of California, Oakland, CA (US)

(72) Inventors: Hamid JAFARKHANI, Irvine, CA (US); Tomas ORTEGA, Irvine, CA (US)

(73) Assignee: The Regents of the University of California, Oakland, CA (US)

(21) Appl. No.: 18/636,406

(22) Filed: Apr. 16, 2024

Related U.S. Application Data
(60) Provisional application No. 63/497,692, filed on Apr. 21, 2023.

(51) Int. Cl. G06N 3/098

(52) U.S. Cl. CPC G06N 3/098

(57) ABSTRACT

Process and device configurations are provided for bidirectional quantized communication and buffered aggregation. In one embodiment, a method is provided for machine communication and to improve machine communication for machine learning models. Quantized communication by a server device can include sampling at least one client device to request a local model update using a hidden state, and receiving a quantized difference for a model of the at least one client device. The method can also include aggregating model updates in a buffer, performing a global update on a server model and updating the hidden state model using the server model. Quantized communication may be used for transmitting a hidden state update to the at least one client device. Processes and devices may also use Gossiped and quantized communication of hidden state model updates to at least one additional node to allow for Online Multi-Kernel Learning (OMKL).

### CROSS REFERENCE TO RELATED APPLICATION

This application claims priority to U.S. provisional application No. 63/497,692 titled SYSTEMS AND METHODS FOR QUANTIZED MACHINE LEARNING, FEDERATE LEARNING AND BIDIRECTIONAL NETWORK COMMUNICATION filed on Apr. 21, 2023, the content of which is expressly incorporated by reference in its entirety.

### STATEMENT OF GOVERNMENT SUPPORT

This invention was made with Government support and is supported in part by Grant No. ECCS-2207457 awarded by the National Science Foundation. The Government has certain rights in the invention.

### FIELD

The present disclosure generally relates to machine operations and communication, including methods for decentralized machine learning, distributed learning, federated learning, asynchronous federated learning, network communication, and machine communication.

### BACKGROUND

Asynchronous Federated Learning with Buffered Aggregation (FedBuff), developed by Meta (Facebook), is a federated learning algorithm known for its efficiency and high scalability. However, FedBuff has a high communication cost. Federated Learning (FL) is a distributed machine learning paradigm that enables training of models on decentralized data, without the need for centralized data storage or sharing of raw data. One of the main challenges in FL is the presence of data heterogeneity and communication constraints. These challenges arise due to distributed data and in particular to data sources that vary. While FL operations provide benefits, there is a need and desire for improved operation and processes.

Many of the latest efforts in machine learning are focused on bringing learning as close to data collection as possible. This is of practical interest in a diverse array of applications and in particular for sensor networks. In sensor networks, nodes are often communication-constrained, operate in a distributive manner, and can send only a few bits to their neighbors. There is a need and a desire for processes that allow for learning with non-fully connected data sources, such as a non-fully connected graph.

### BRIEF SUMMARY OF THE EMBODIMENTS

Disclosed and described herein are systems, methods and configurations for bidirectional quantized communication and buffered aggregation. In one embodiment, a method is provided for bidirectional quantized communication and buffered aggregation including sampling, by a server device, at least one client device, wherein the sampling includes a request to update a local model of the client device using a hidden state model, and receiving, by the server device, a quantized difference for the local model of the at least one client device. The method also includes aggregating, by the server device, model updates in a buffer, and performing, by the server, a global update on a server model using the model updates in the buffer. The method also includes updating, by the server device, the hidden state model using the server model, and transmitting, by the server device, a hidden state model update to the at least one client device.

In one embodiment, sampling the at least one client device includes a request for local updates to the hidden state model from the at least one client device, and wherein the local updates are determined following training by the at least one client device.

In one embodiment, the server model is a Quantized Federated Learning Model with Buffered Aggregation (QAFeL).

In one embodiment, the quantized difference includes a compressed set of hidden state model updates determined by the at least one client device.

In one embodiment, the quantizer compresses updates to the hidden state model including a function with a compression parameter, and an internal randomness parameter, the function configured to reduce trained dataset updates to a quantized set of data updates.

In one embodiment, aggregating model updates in the buffer includes determining quantized model updates, the quantized model updates providing training feedback for the local model and hidden state model.

In one embodiment, the global update includes updating a server model on the server device based on aggregated training updates received for the hidden state model from at least one client device.

In one embodiment, updating the hidden state model includes modifying a hidden state model using an updated server model on the server device.

In one embodiment, transmitting the hidden state model update includes broadcasting a modified hidden state model to the at least one client device.

In one embodiment, the at least one client device performs a gossiped and quantized communication of hidden state model updates to at least one additional node.

Another embodiment is directed to a system for bidirectional quantized communication and buffered aggregation. The system includes at least one client device, and a server device. The server device includes a controller configured to sample the at least one client device, wherein sampling includes a request to update a local model of the client device using a hidden state model, and receive a quantized difference for a local model of the at least one client device. The controller is configured to aggregate model updates in a buffer, and perform a global update on a server model using the model updates in the buffer. The controller is configured to update the hidden state model using the server model, and transmit a hidden state model update to the at least one client device.

In one embodiment, the system is a Quantized Federated Learning system with Buffered Aggregation (QAFeL).

In one embodiment, the client device includes an unbiased quantizer configured to generate a quantized difference for the model of the at least one client device and the hidden state model.

In one embodiment, the quantizer compresses updates to the hidden state model including a function with a compression parameter, and an internal randomness parameter, the function configured to reduce trained dataset updates to a quantized set of data updates.

In one embodiment, aggregating model updates in the buffer includes determining quantized model updates, the quantized model updates providing training feedback for the local model and hidden state model.

In one embodiment, the global update includes updating a server model on the server device based on aggregated training updates received for the hidden state model from at least one client device.

In one embodiment, the at least one client device performs a gossiped and quantized communication of hidden state model updates to at least one additional node.

Another embodiment is directed to a method for bidirectional quantized communication and buffered aggregation including receiving, by a client device, a hidden state model, the hidden state model based on a server device model. The method also includes training, by the client device, a local model to determine updates for the local model. The method also includes receiving, by client device, a request to transmit updates determined for the local model of the client device, and generating, by the client device, a quantized difference for the local model and the hidden state model. The method also includes transmitting, by the client device, a quantized difference to the server device.

In one embodiment, the model is a Quantized Federated Learning Model with Buffered Aggregation (QAFeL).

In one embodiment, generating a quantized difference is performed by an unbiased quantizer for the client device configured to perform a gossiped and quantized communication of hidden state model updates to at least one additional node.

Another embodiment is directed to a method for gossiped and quantized communication and learning. The method includes sampling, by a client device, at least one neighboring client device, wherein sampling includes a request for the at least one neighboring client device to update a local model of the at least one neighboring client device using a hidden state model. The method also includes receiving, by the client device, a quantized difference for the local model of the at least one neighboring client device, and aggregating, by the client device, model updates in a buffer. The method also includes performing, by the client device, a global update on a client model using model updates from the at least one neighboring client device in the buffer, and updating, by the client device, the hidden state model of the client device using the client model. The method also includes transmitting, by the client device, a hidden state model update to the at least one neighboring client device, wherein the client device performs a gossiped and quantized communication of hidden state model updates to the at least one neighboring client device.

Other aspects, features, and techniques will be apparent to one skilled in the relevant art in view of the following detailed description of the embodiments.

### BRIEF DESCRIPTION OF THE DRAWINGS

The application file contains at least one drawing executed in color. Copies of this patent or patent application publication with color drawing(s) will be provided by the Office upon request and payment of the necessary fee.

The features, objects, and advantages of the present disclosure will become more apparent from the detailed description set forth below when taken in conjunction with the drawings in which like reference characters identify correspondingly throughout and wherein:

FIG. 1 is a graphical representation of a system and bidirectional quantized communication according to one or more embodiments;

FIG. 2 illustrates a process for bidirectional quantized communication and buffered aggregation according to one or more embodiments;

FIG. 3 depicts a device configuration according to one or more embodiments;

FIG. 4A illustrates a system according to one or more embodiments;

FIG. 4B illustrates a process for bidirectional quantized communication and buffered aggregation according to one or more embodiments;

FIG. 5A illustrates a graphical representation of Quantized Asynchronous Federated Learning (QAFeL) according to one or more embodiments;

FIGS. 5B-5D illustrates processes for Quantized Asynchronous Federated Learning (QAFeL) according to one or more embodiments;

FIG. 6 illustrates communication metrics according to one or more embodiments;

FIG. 7 illustrates communication metrics according to one or more embodiments;

FIG. 8 illustrates process/algorithm 800 for gossiped and quantized OMKL at a node according to one or more embodiments;

FIG. 9 illustrates comparison of kernel learning processes according to one or more embodiments;

FIG. 10 illustrates a graphical representation of graph topology without quantization according to one or more embodiments;

FIG. 11 illustrates a graphical representation of synchronous and asynchronous federated learning;

FIG. 12 illustrates a graphical representation of updating a hidden state according to one or more embodiments; and

FIG. 13 illustrates a process for quantized communication and learning according to one or more embodiments.

### DETAILED DESCRIPTION OF THE EXEMPLARY EMBODIMENTS

### Overview and Terminology

One aspect of the disclosure is directed to machine learning including systems and methods for machine communication. In one embodiment, processes and configurations are provided for bidirectional quantized communication for asynchronous federated learning and buffered aggregation. Operations and configurations discussed herein improve machine communication and performance of machine learning operations. Embodiments are directed to Quantized Asynchronous Federated Learning (QAFeL), with a quantization scheme that establishes a shared “hidden” state between the server and clients, and that is continuously updated through quantized updates. The shared hidden state may be model shared between a server device and client devices, and may operate as a reference for updating a global model. The hidden model may be referred to herein as a client background model. Systems and processes according to embodiments provide high precision while significantly reducing the data transmitted during client-server interactions. In addition, systems and processes discussed herein provide theoretical convergence guarantees for asynchronous Federated Learning (FL) with quantized communications and buffered aggregation, in both directions of server-to-client and client-to-server.

According to embodiments, systems may be configured for distributed learning and federated learning, where the data may be kept at users and a global model is trained by communicating the models trained at each node or the gradients calculated at each node. Embodiments improve communication among the nodes, between clients and with one of more server devices (e.g., cloud). Embodiments provide solutions to the large communication bandwidth required for communication, the bandwidth requirement may be a bottleneck to conventional systems. Embodiments may address communication bottlenecks in a system by introducing a quantization method and system that can be used to reduce the transmitted bits while maintaining performance for a system.

Operations may also be directed to models and systems for asynchronous FL methods, as FL may be suited to handle large-scale and dynamic systems. In asynchronous FL, clients and nodes in a system may be configured to update models independently and can also communicate with a server at different times. This eliminates the need for fitting clients into time slots, allows the handling of clients that are slow to respond or have limited communication capabilities. Embodiments also provide operations to address challenges of asynchronous learning such as stale gradients and stragglers, which need to be handled properly to ensure performance.

Embodiments also provide systems and processes that allow for communication and operations for Online Multi-Kernel Learning (OMKL). Configurations may include communication among nodes with quantized communication. Processes and device configurations can include using a shared “hidden” state. In instances of online kernel learning where little prior information is available and centralized learning is unfeasible, online multi-kernel learning may provide sub-linear regret as long as every pair of nodes in the network can communicate (i.e., the communications network is a complete graph). According to embodiments, to manage the communication load, which is often a performance bottleneck, communications between nodes can be quantized. Processes and system configurations are provided for non-fully connected graphs, which is often the case in wireless sensor networks. According to embodiments, a gossip algorithm is provided as well as experimental results to achieve sub-linear regret. Experiments with real datasets are described that confirm operation of the embodiments.

According to embodiments, processes and device configurations may be configured to provide models and machine processes for natural language processing, computer vision, and health-care, network communication and computer operations in general.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment, certain embodiments, an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

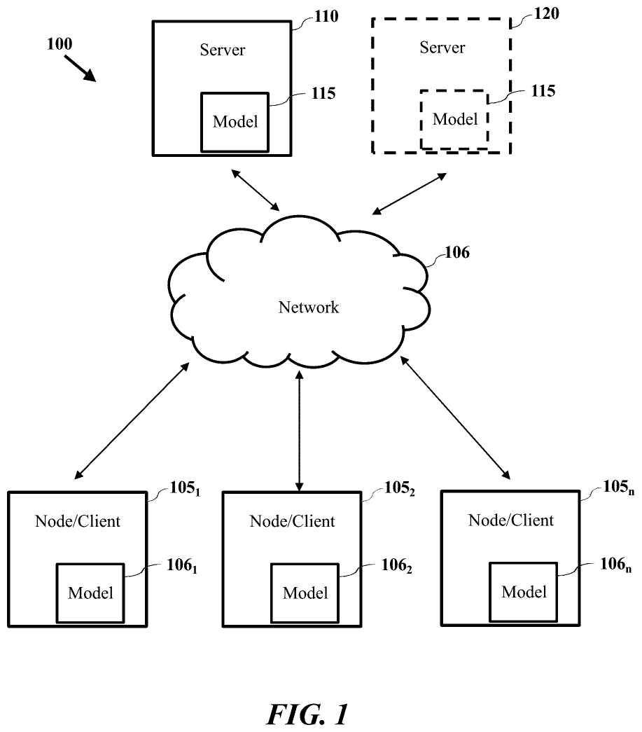

FIG. 1 is a graphical representation of a system and bidirectional quantized communication according to one or more embodiments. According to embodiments, systems, methods and device configurations provide bidirectional communication for learning applications, including model training, and to provide models and machine processes for natural language processing, computer vision, health-care, network communication and computer operations in general. System 100 is configured for distributed machine learning using a model. According to embodiments, system 100 includes at least one client device, such as nodes/clients 105₁₋ₙ, which may be configured to store and process data for training local client models 106₁₋ₙ. According to embodiments, system 100 includes at least one server device 110 which includes a model 115. Server device 110 may be configured to received training updates from one or more of nodes/clients 105₁₋ₙ by way of network 106. Server device 110 may be configured to update model 115 by aggregating model updates from one or more of nodes/clients 105₁₋ₙ. According to embodiments, server 110 may be configured for asynchronous federated learning with bidirectional quantized communications and buffered aggregation, such as process 200.

According to embodiments, system 100 is configured for distributed machine learning, and for using and training models on decentralized data, such as data stored or accessed by nodes/clients 105₁₋ₙ. According to embodiments, server device 110 may include a controller configured to sample at least one client device, such as one or more of nodes/clients 105₁₋ₙ. According to embodiments, sampling can include transmitting a request to at least one of the nodes/clients 105₁₋ₙ to update a local model of a client device using a hidden state. According to embodiments, a hidden state model may be used and shared between at least one server device and nodes/clients 105₁₋ₙ to update a model. According to embodiments, system 100 may use quantized communication for sharing updates relative to nodes/clients 105₁₋ₙ and server 110. The controller of server 110 may also be configured to receive a quantized difference for a model of the at least one client device, and aggregate model updates in a buffer. The controller is also configured to perform a global update on a model using the model updates in the buffer, and update the hidden state using the model. According to embodiments, the controller is configured to transmit a hidden state update to the at least one of the nodes/clients 105₁₋ₙ.

According to embodiments, system 100 may include one or more servers, such as server device 110 and optional server device 120. Optional server device 120 may also store model 115 and be configured for updating model 115 and receiving quantized updates.

According to embodiments, system 100 may be configured to provide distributed learning and federated learning. As such, data for machine learning operations may be stored at users, such as one or more of nodes/clients 105₁₋ₙ and a global model, such as model 115, is trained by communicating the models trained at each node, such as models 106₁₋ₙ, or the gradients calculated at each node. Nodes/client devices 105₁₋ₙ may include an unbiased quantizer configured to generate a quantized difference for a local model, such as a model of the at least one client device and a hidden state model.

According to embodiments, system 100 may allow for communication among nodes, such as nodes/clients 105₁₋ₙ, and/or between clients, such as nodes/clients 105₁₋ₙ, and network 106, which may provide one or more cloud network services. System 100 and configurations and processes discussed herein allow for high communication throughput challenges to be met. According to embodiments, communication bottlenecks may be overcome by quantization to reduce the transmitted bits while maintaining the performance. Operations and processing including quantization may be applied to other distributed machine learning processes. By way of example, processes and configurations herein may provide a Quantized Asynchronous Federated Learning (QAFeL), with a quantization scheme that establishes a shared “hidden” state between the server and clients and is continuously updated through quantized updates. The QAFeL operations discussed herein can provide high precision while significantly reducing the data transmitted during client-server interactions. In addition, the processes can provide convergence guarantees for asynchronous Federated Learning with quantized communications and buffered aggregation, in both directions of server-to-client and client-to-server. Experimental results are discussed herein supporting the machine improvements.

According to embodiments, one or more of nodes/clients 105₁₋ₙ may be configured for communication across nodes of system 100 and for Quantized Online Multi-Kernel Learning (OMKL). Operations are provided for a complete graph or fully connected nodes (e.g., every pair of nodes in the network can communicate), and non-fully connected nodes. According to embodiments processes and device configurations are provided for nodes/client devices 105₁₋ₙ to provide quantized communications. Nodes/client devices 105₁₋ₙ may provide configurations to expand OMKL to non-fully connected graphs, which is often the case in wireless sensor networks, by utilizing a gossip algorithm. In embodiments, nodes/client devices 105₁₋ₙ can perform gossiped and quantized communication of hidden model state updates to at least one additional node.

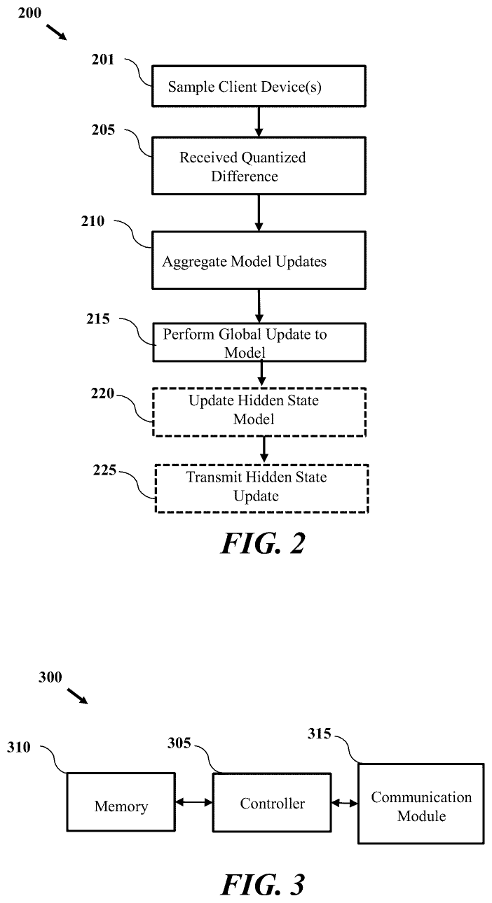

FIG. 2 illustrates a process for bidirectional quantized communication and buffered aggregation according to one or more embodiments. Process 200 may be performed by a system (e.g., system 100) to provide machine communication for machine learning including updating a machine model. Process 200 may also be performed as part of applying a machine model. Process 200 may be performed for updating a machine model and communication with one or more nodes/client devices. According to embodiments, a service device (e.g., server device 110) may be configured to perform one or more operations of process 200 for machine communication. According to embodiments, process 200 may be performed with a server device sharing a hidden model with client devices. The hidden model may be a copy of a global model, model parameters, and/or model data that may be used by a node or a client to determine updates and information for training a global model. Client devices may use the hidden model as a reference.

Process 200 may be initiated at block 201 with sampling at least one client device. Sampling can include a sending a request from a server device to at least one node/client device to update a local model of the client device using a hidden state. Client devices may train asynchronously based on data available, data received and inputs to the client devices. Sampling the at least one client device can include a request for local updates to the hidden state from the at least one client device, and the local updates may be determined following training by the at least one client device. According to embodiments, process 200 may be configured to provide a communication process for Quantized Federated Learning Model with Buffered Aggregation (QAFeL). The model may be a global model for a system, where a server level model is updated and communicated to one or more nodes or client devices. According to embodiments, the model may be for one or more of machine learning, distributed learning, and federated learning. Process 200 and embodiments provide communication efficient methods for performing gossip/consensus distributed machine learning and asynchronous federated learning. In addition, process 200 may be performed for asynchronous Federated Learning with Buffered Aggregation (FedBuff).

At block 205, process 200 includes at least one server device (e.g., server 110) receiving a quantized difference for a model of the at least one client device. Client devices of a system, such as nodes/client devices 105₁₋ₙ of system 100 may communicate relative to each other and relative to one or more servers. In response to sampling at least one client device at block 201, a server device of process 200 may receive information and data from one or more node/client devices to update a server model. According to embodiments, a quantized difference may be received including a compressed set of hidden model updates determined by the at least one client device. The quantizer may compress updates to the hidden model state including a function with a compression parameter, and an internal randomness parameter, the function configured to reduce trained dataset updates to a quantized set of data updates. Compression of updates may be performed using a quantizer and/or quantizer operations as a form of lossy compression that allows for a reduced message and fewer communication bits than a full model package of updates.

At block 210, process 200 includes aggregating model updates in a buffer, and at block 215 performing a global update on a server model using the model updates in the buffer. A server device may aggregate client updates for a period of time prior to updating a model. Updates received from one or more clients (e.g., nodes) may be stored as received. Aggregating model updates in the buffer may include determining quantized model updates. Quantized model updates may provide training feedback for the local model and hidden state. The global update includes updating a model on the server device based on aggregated training updates received for the hidden model state from at least one client device. Aggregating for the global update can include averaging local updates received from clients to form a global update. The global update may be based on a weighted mean of the local updates and/or based on an aggregation type.

At block 220, process 200 optionally includes updating the hidden state model using the server model. Process 200 may also optionally include transmitting a hidden state update to the at least one client device at block 225. Updating the hidden state model can include modifying a hidden model using an updated server model on the server device. Transmitting the hidden state update includes broadcasting a modified hidden model state to the at least one client device.

According to embodiments, a node/client device (e.g., nodes/client devices 105₁₋ₙ) may be configured to perform one or more operations of process 200 for machine communication. In particular, a node/client device may perform gossiped and quantized communication and learning without a server (e.g., server 110). By way of example, process 200 may be performed as a gossiped version, where there is no need for a server in order for one or more processes and system configurations described herein to operate. By way of further example, without any server, clients can exchange information with each other. Exchange an updating of hidden state models may eventually lead to convergence of local models to a global model.

According to embodiments, process 200 may illustrate a method for gossiped and quantized communication and learning performed by a node/client device. As such, process 200 may illustrate one or more operations performed by the node client device, such as nodes/client devices 105₁₋ₙ of system 100. According to embodiments, process 200 may include a client device sampling at least one neighboring client device at block 201, wherein sampling includes a request for the at least one neighboring client to update a local model of the at least one neighboring client device using a hidden state model. At block 205, the client device may receive a quantized difference for the local model of the at least one neighboring client device. At block 210, the client device may aggregate model updates in a buffer. At block 215, the client device may perform a global update on a client model using model updates from the at least one neighboring client device in the buffer. The client device may optionally update the hidden state model of the client device using the client model at block 220. The client device may optionally transmit a hidden state model update to the at least one neighboring client device, wherein the client device performs a gossiped and quantized communication of hidden state model updates to the at least one neighboring client device.

FIG. 3 depicts a device configuration according to one or more embodiments. Device 300 may relate to a server device or components of a device or server configured to provide a model for machine learning and application of the model to one or more inputs. According to one embodiment, device 300 includes controller 305, memory 310 and communications module 315. According to embodiments, device configuration 300 may be used by a server device (e.g., server device 110) and/or a node/client device (e.g., node/client device 105₁).

Controller 305 may relate to a processor or control device configured to execute one or more operations stored in memory 310, such as providing bidirectional quantized communication and buffered aggregation. Communications module 315 may be configured to communicate with one or more other devices, such as a server device (e.g., sever 110) or node/client device (e.g., node/client device 105₁).

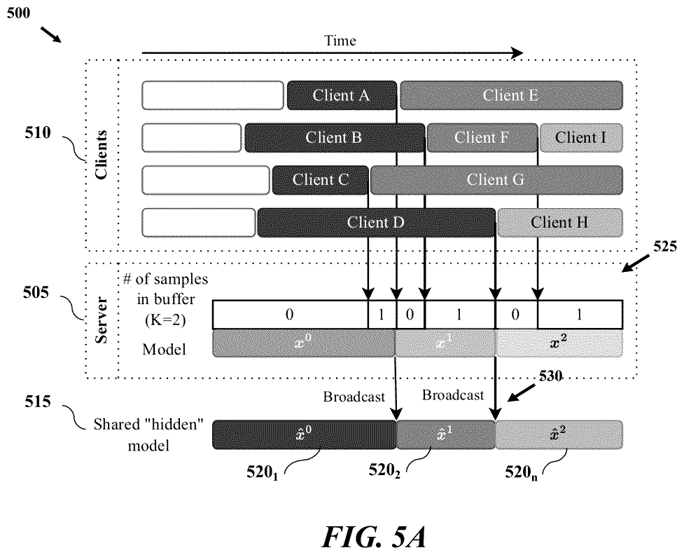

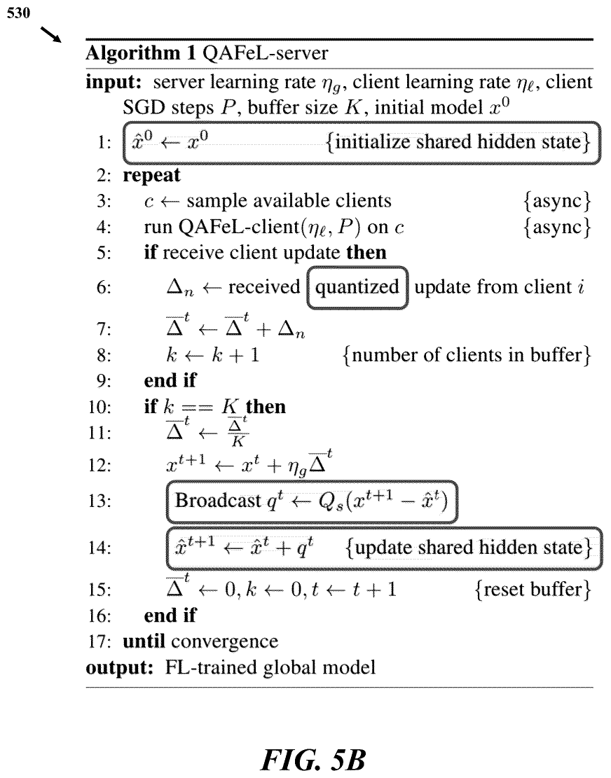

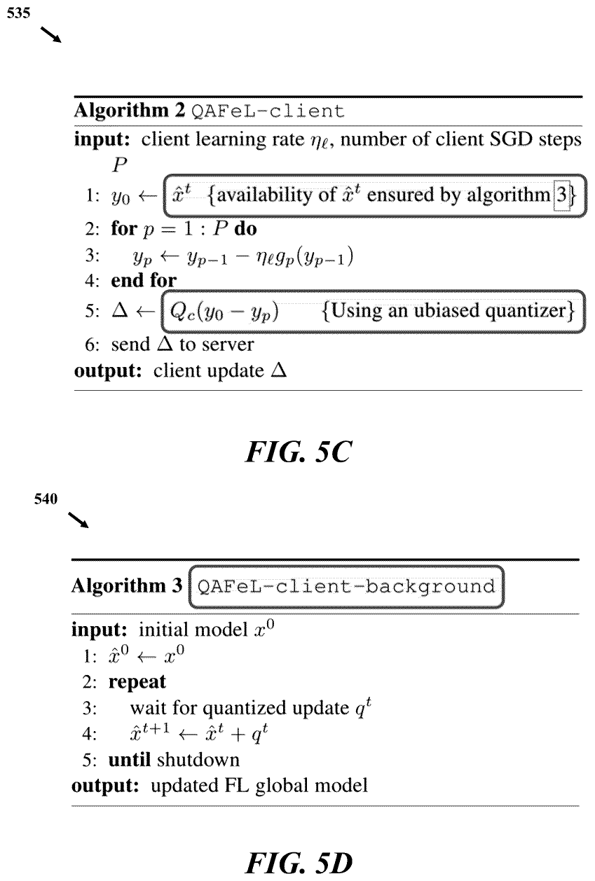

According to one embodiment, controller 305 may be configured to sample client devices, receive client device quantized differences, aggregate model updates and perform global updates to a model. Controller 305 may also direct updates and control transmission and broadcasting of hidden state updates to one or more client devices. Server device 300 may include one or more components for receiving and detecting communications from other devices. Server device 300 and controller 305 may also be configured to aggregate updates from one or more client devices and perform processes, such as process 200 of FIG. 2 and quantized aggregation of FIG. 5A. According to embodiments, the device configuration of FIG. 3 and controller 305 may be used as a client device for the purposes of updating models and machine communication among nodes/client devices.

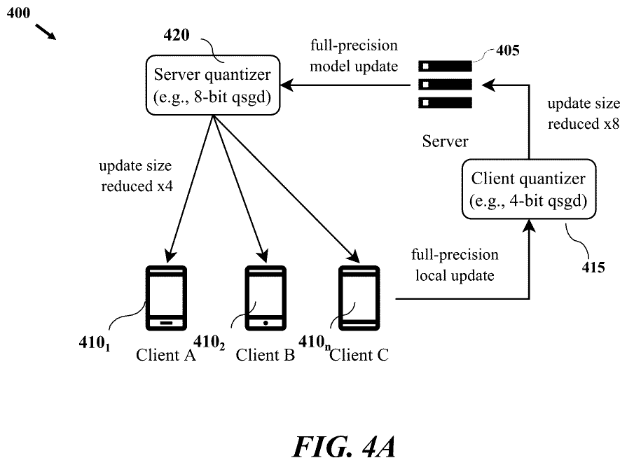

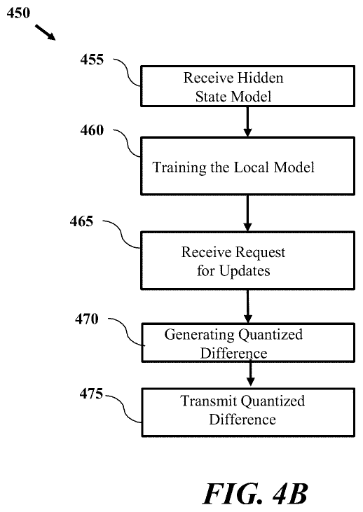

FIG. 4A illustrates a system according to one or more embodiments. System 400 is configured for distributed machine learning using a model and bidirectional quantized communication. According to embodiments, system 400 includes at least one server device 405 and at least one client device, such as client devices 410₁₋ₙ. Client devices 410₁₋ₙ may be configured to store and process data for training local client models (e.g., local client models 106₁₋ₙ). According to embodiments, system 400 includes at least one server device 405 which includes a model, such as a global model. Server device 405 may be configured to receive training updates from one or more of client devices 410₁₋ₙ. Server device 405 may be configured to update a model by aggregating model updates from one or more of client devices 410₁₋ₙ. According to embodiments, bidirectional quantizing can including quantizing updates at block 415 from client devices 410₁₋ₙ and/or a server quantizing updates at block 420 from server 405.

According to embodiments, server 425 may be configured for asynchronous federated learning with bidirectional quantized communications and buffered aggregation, such as process 200. Asynchronous federated learning with bidirectional quantized communications and buffered aggregation can provide a tighter convergence rate, compared to non-quantized communications, and allow for non-convex functions and heterogeneous clients, without assuming bounded client heterogeneity. System 400 provides a bidirectional quantization scheme into a buffered process (e.g., FedBuff) and can provide a Quantized Asynchronous Federated Learning (QAFeL) process. The QAFeL process also includes a hidden shared state between a server device and clients and facilitates a reduction in communication costs. According to embodiments, a QAFeL process includes client devices 410₁₋ₙ training asynchronously, and that are configured to send local updates to a server when the client devices 410₁₋ₙ are finished training. Server 420 may be configured to accumulate local updates in a buffer until a maximum capacity is reached and then produce a server model update. According to embodiments, system 400 and operations at block 415 and 420, which may be performed by client devices, server devices and devices in a network in general, may be configured to compress updates. Compression of updates may be performed using a quantizer and/or quantizer operations as a form of lossy compression that allows for a reduced message and fewer communication bits than a full model package of updates.

According to embodiments, a quantizer and/or quantizer operations may be performed by a device, such as a server device 405 or client devices 410₁₋ₙ. According to embodiments, a quantizer may include one or more functional operations. According to embodiments, a quantizer may be denoted by Q: [symbol] →, is a function (possibly random) that satisfies the following condition:

$${𝔼}_{Q} [ {‖ Q ( x ) - x ‖}^{2} ] \leq ( 1 - δ ) {‖ x ‖}^{2} ,$$

where δ>0 is a compression parameter and [symbol] _{Q} denotes the expectation with respect to internal randomness of the quantizer Q, wherein quantizer and compression operator are used interchangeably herein. As an example, the quantizer may use a vector x∈ [symbol] ^{d}, and operate with the definitions
topₖ(x) sends the largest k out of the d coordinates of x.
randₖ(x) sends k out of the d coordinates of x, chosen at random.
qsgdₛ(x), given a positive integer s that sets the number of quantization levels, sends bits that represent ∥x∥, sign(x), and ξ(x,s),

$${ξ}_{i} ( x , s ) = \{ \begin{matrix}⌈ \frac{{x}_{i} \cdot s}{‖ x ‖} ⌉ \\ ⌊ \frac{{x}_{i} \cdot s}{‖ x ‖} ⌋\end{matrix}$$

with probability

$$\frac{{x}_{i} \cdot s}{‖ x ‖} - ⌊ \frac{{x}_{i} \cdot s}{‖ x ‖} ⌋ ,$$

otherwise and the receiver can reconstruct

$$\frac{‖ x ‖}{s} \cdot sign ( x ) \cdot ξ ( x , s ) , .$$

For topₖ and randₖ, their compression parameter is δ k/d. For a qsgd with s levels of quantization,

$$δ = 1 - min ( \frac{2 d}{{s}^{2}} , \frac{\sqrt{2 d}}{s} ) .$$

The topₖ may be the only biased quantizer of the three and the general biased quantizers may be converted to unbiased quantizers with additional data transmission. According to embodiments, n bits may be used per coordinate instead of a full precision floating point number, which is usually 232 bits. This n-bit qsgd quantizer and the number of bits per coordinate, n, may automatically determine the quantization level s.

FIG. 4B illustrates a process for bidirectional quantized communication and buffered aggregation according to one or more embodiments. According to embodiments, a process is provided for operations of a client device (e.g., node/client devices 105₁₋ₙ) in connection with bidirectional quantized communication and buffered aggregation. Process 450 may be initiated by a client device receiving a hidden state model at block 455. The hidden state model may be based on a model stored and managed by a server device (e.g., server device 405). At block 460, the client device may perform training of a local model to determine updates for the local model. Training of the local model may be based on parameters of the hidden state model. At block 465, the client device may receive a request to transmit updates determined for the local model of the client device. The request may be received from a server device. At block 470, the client device may generate a quantized difference for the local model and the hidden state model. At block 475, process 400 may include transmitting a quantized difference to the server device.

FIG. 5A illustrates a graphical representation of Quantized Asynchronous Federated Learning (QAFeL) process according to one or more embodiments. According to embodiments, process for machine communication 500 may include operations from server 505, and one or more client devices 510. According to embodiments, server 505 and client devices 510 may operate using a shared hidden model 515. Server 505 may make updates 520₁₋ₙ to the shared hidden state model based on aggregated updates from one or more client devices.

In FIG. 5A, server 505 asynchronously samples clients and requests that a client provide updates based on training the client device is performing. The client device may provide training based on inputs to the client device and a local training data set. Clients may determine client updates based on a client copy of a hidden state or hidden state model. The client device may perform local updates to a client local model and determine differences between the client local model and the hidden state model. Differences between the two models may be used to identify updates to a server. According to embodiments, the updates may be quantized to improve communication. According to embodiments, client devices 510, which may include a plurality of nodes/client devices, may send updates, shown generally as 525, to server 505. Server 505 may update the hidden shared model, updates to the hidden state model shown generally as 530.

According to embodiments, communication between nodes may be quantized. Client devices or nodes may be configured to quantize data by using a function to select parameters and models for providing updates. Quantizing updates may reduce one or more of the data transmissions, and data size provided for updates. Process 500 may allow for quantized communication in both directions, such that client devices may send quantized updated to a server device and a server device may send quantized updates to a client devices. Process 500 may also be applied to a network complete graph and non-fully connected graphs. For non-fully connected graphs a gossip algorithm may be used, such as process 800.

Process 500 illustrates an example timeline for execution of QAFeL. According to embodiments, the hidden model or hidden state 515 may be shared between clients and a server device. The hidden state model may be saved in server memory and each client and may be used as an approximation of the server model at each client. The hidden state model can save communication costs while guaranteeing convergence, since both clients and the server know the values of the hidden model. According to embodiments, the server may be configured to send a quantized difference between the hidden state model and the server model at each iteration to progressively improve the approximation. In FIG. 5A, the hidden model is shown separately from the server and clients to initiate that it may be synchronized, while in practice the clients and server may store separate copies. FIG. 5A illustrates an exemplary timeline with a server and buffer for K=2 samples. In FIG. 5A, arrows from clients to the server indicate quantized messages and black arrows from the server to the hidden model indicate a quantized broadcast message.

According to embodiments, a QAFeL process and model may be configured to accommodate networks without broadcast capabilities. In this case, the server must keep hidden state updates in storage for a maximum of Cₘₐₓ updates, where Cₘₐₓ is the storage size of the model divided by the expected size of a compressed hidden state, and then transmit the necessary updates so that the hidden state is synchronized between the client and server. If the staleness is larger than Cₘₐₓ, the server can transmit the hidden state to the client. In each scenario, the communication cost is improved of prior communication formats.

According to embodiments, a global loss function can be based on minimizing the weighted sum of the client loss functions

$$\begin{matrix}min \\ x ∈ {ℝ}^{d}\end{matrix} f ( x ) := \frac{1}{N} {\sum }_{n = 1}^{N} ( {F}_{n} ( x ) := {𝔼}_{Ϛ n} [ {F}_{n} ( x ; {Ϛ}_{n} ) ] )$$

where Fₙ is the loss function on Client n and N is the total number of clients. The global loss function minimizes the average of local loss functions, which is the same as minimizing the sum of the client loss functions with equal weights 1/N. Each function Fₙ depends only on data collected locally (i.e., client n) and the notation is summarized in Table 1:

TABLE 1

| | |
|---|---|
| x^{t}, \hat{x}^{t} | server, shared hidden state at time t |
| P, p | number, index of local steps at client |
| K, k | number, index of clients at buffer |
| N, n | number, index of total clients |
| L | loss gradient smoothness constant |
| n_{g}, nₗ^{(p)} | server, client (at step p) learning rates |
| Qₛ, Q_{c} | server, client quantizers |
| δₛ, δ_{c} | server, client compression parameters |
| Δ̅^{t}, Δₖ^{t} | server, client k's update at time t |

Assumptions may be made for all clients including bounded local variance, bounded and L-smooth loss gradient, and bonded staleness when K=1. It may be assumed that ƒ achieves a minimum value at ƒ*. The upper bound of the staleness may depend on the buffer size, K. As the buffer size increases, the server may update less frequently, which reduces the number of server steps between when a client starts training and when the updates are applied to the global model.

According to embodiments, to alleviate the communication cost of asynchronous FL, with buffered aggregation, a QAFeL process may include models such as a QAFeL-server (e.g., server model), a QAFeL client (e.g., client device model) and QAFeL client background (e.g., hidden state model). FIGS. 5B-5D illustrates processes for Quantized Asynchronous Federated Learning (QAFeL) that can operate with one or more of the QAFeL server model, QAFeL client model and QAFeL client background model. FIG. 5B illustrates process 530 (e.g., /algorithm) for a QAFeL server model which runs in a server device. According to embodiments, process 530 includes initializing a shared hidden state, or shared model, between a server device and one or more client devices and nodes. Client devices may generate updates to a hidden model based on training and received inputs, and quantize output data to the server. The server device may receive the quantized input and aggregate updates in a buffer. The server device may update the hidden state and transmit the updated hidden state model to the client devices. Transmission of the hidden state model may include quantizing the updates to reduce the data size. FIG. 5C illustrates a process/algorithm 535 for a QAFeL client model which runs on a client device or node to provide client device updates. Process 535 may be performed by a client and may include performing machine operations for a learning model based on received input and quantizing updates to a hidden state model. FIG. 5D illustrates a process/algorithm 540 for a QAFeL background model which clients may be running as a background operations. Process 540 may be performed in a background, to update and store a global model or server model based on received updates.

According to embodiments, quantized data may be a full set of model updates minimized based on a server device and client maintaining a common shared hidden state. To begin training the server device and one or more client devices may start with a pre-agreed upon model, which may be used to initiate a hidden state. The server device may then asynchronously sample clients and request the clients to compute a local update. A requested client device may copy the current hidden state and perform P local updates using the equation

$${y}_{p} ← {y}_{p - 1} - {η}_{l} {g}_{p} ( {y}_{p - 1} )$$

where ne is the local learning rate and gₚ is the noisy gradient. After the local updates are computed, the client device can send the quantized difference Q_{c}(yₚ₋₁−yₒ) to the server to aggregate. The server can accumulate updates in a buffer until it has K samples and then performs a global update on the model using the equation

$${x}^{t + 1} ← {x}^{t} + {η}_{g} \frac{{\overline{Δ}}^{t}}{K}$$

Where Δ̅^{t} is the sum of local updates from the buffer. The server then updates the hidden state by computing q^{t}←Q_{c}(x^{t+1}−x^{t}) and broadcasting the hidden state model to the clients. The clients have a process in the background that collects q^{t}. Then both the server and the clients perform a hidden state update

$${\hat{x}}^{t + 1} ← {\hat{x}}^{t} + {q}^{t} .$$

According to embodiments secure aggregation may be used and the QAFeL algorithm may extend processes such as FedBuff without interfering with a privacy scheme.

According to embodiments, operations discussed herein provide improved convergence. According to embodiments, a condition may be provided on the learning rates necessary for the convergence to hold, such as a bounded rate. For the case of biased server quantizers, a looser bound on the convergence rate may be provided. By selecting local and global learning rates that satisfy the condition and unbiased server and client quantizers, the ergodic convergence rate of a QAFeL model may have an upper bound. In addition, the selection of a client quantizer may affect the order of error more than the choice of a server quantizer.

Experimental results of processes and operations of embodiments include results from a series of simulations to evaluate the performance of a QAFeL. Simulations were performed to evaluate the reduction in communication load between a client and server in regard to a federated learning model with buffered aggregation and to assess the impact of different quantization techniques on the convergence speed. A standard metric for comparing synchronous and asynchronous learning methods may be the number of client trips, which can include the number of times the client downloads the model and uploads and updated version after training. In addition, the number of bytes per message may also be illustrative of the benefits of processes and operations according to embodiments.

A trade-off may be in place with respect to the amount of quantization and the speed of convergence. In other words, compressing more will send less bytes per message, but more messages will have to be sent to provide target accuracy. According to embodiments, a QAFeL may require less total number of communication bits compared to conventional methods including FEDBUFF. According to embodiments, an optimal level of quantization, may be based on the quantizer.

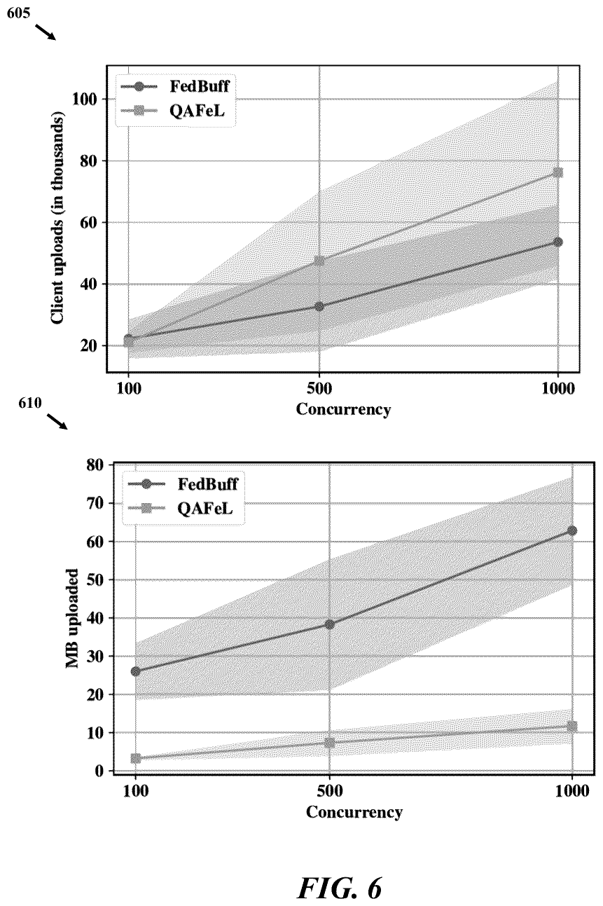

FIG. 6 illustrates communication metrics according to one or more embodiments. According to embodiments experimental results were determined using a convolutional neural network (CNN) classifier as a model. FIG. 6 illustrates communication costs including number of client uploads 605 relative to concurrency and data upload size (e.g., MB) 610 relative to concurrency for a QAFeL process compared to a FedBuff process. The simulated QAFeL processes achieved lower communication costs compared to FedBuff, including a 5.2-8× decrease in MB uploaded, and an analogous decrease in MB broadcasted. The number of client updates is 1-1.5× higher, but using a 4 bit qsgd quantization in each direction accounts for approximately a 8× reduction in message size. The decrease in upload and broadcast required communication includes extra client updates.

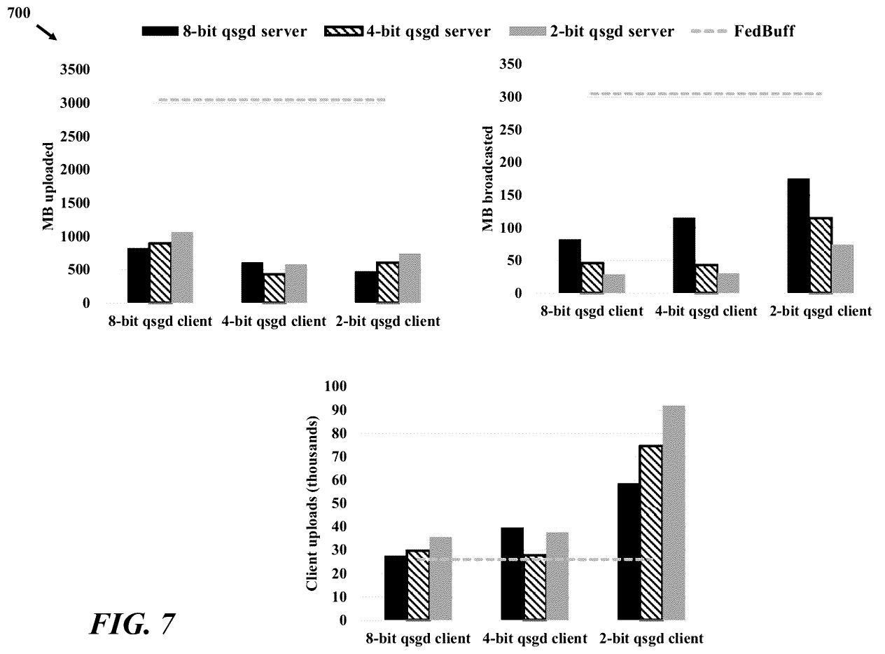

FIG. 7 illustrates communication metrics according to one or more embodiments. Performance 700 of a QAFeL process for operations of different quantizers are provided. Performance 700 illustrates communication metrics of a QAFeL and FedBuff to reach target validation accuracy (90%) with varying choice of qsgd quantizers. In all cases, QAFeL saves at least 3× upload cost and 2× broadcast cost. In the 4-bit qsgd client and server, the convergence speed is the same for both algorithms, and upload message size is reduced from 3052 MB to 428 MB, a 7× decrease with analogous decrease in download cost. As shown in the experimental results, the effect of the server quantizer is less pronounced than the client quantizer. Given a client quantizer quantizing with less precision at the server results in lower total data downloaded. However, quantizing with less precision at the client sometimes results in more total data uploaded, from 4 to 2 bit qsgd at the client, with 8-bit qsgd at the server. FIG. 7 illustrates that the number of uploads is improved from 4 bit to 2 bit per qsgd, with no significant reduction in total upload bytes. These results suggest a quantization precision versus convergence speed trade-off, which is specific to each combination of quantizers.

Results of experiments support the quantization schemes as providing a specific convergence rate and how quantization at the client can be controlled to affect the performance of a QAFeL more than server quantization.

According to embodiments, processes are provided for gossiped and Quantized Online Multi-Kernel Learning (OMKL). Device configurations described herein (e.g., server device 110, node clients 105₁₋ₙ) may be configured for online kernel learning. OMKL use may result in sub-linear regret as long as every pair of nodes in the network can communicate (i.e., the communications network is a complete graph), even when little prior information is available. According to embodiments processes and device configurations are provided for managing communication load, which is often a performance bottleneck, and to provide quantized communications between. Embodiments provide configurations to expand OMKL to non-fully connected graphs, which is often the case in wireless sensor networks. To address this challenge, embodiments can utilize a gossip algorithm. Experimental results are also discussed.

According to embodiments, a network may be characterized as having J nodes and the network may be modeled as an undirected connected graph. At each instant of time t, Node j may receive a data string xₜ^{j}∈ [symbol] ^{d} and the desired response yₜ^{j}∈ [symbol] ^{d}. An approximating function ƒ(xₜ^{j}) may be determined for yₜ^{j}. The function ƒ may belong to a Reproducing Kernel Hilbert Space (RKHS) [symbol] ={ƒ|ƒ(x)=Σₜ₌₁^{∞}Σₜ₌₁^{∞}αₜ^{j}(x, xₜ^{j})} where C is a cost function and λ>0 is a regularization parameter that controls an increasing function Ω. An optimal solution for this problem exists in the form \hat{ƒ}(x)=Σₜ₌₁^{T}Σ_{J=1}^{J}αₜ^{j}k(x, xₜ^{j})=α^{T}k(x), where α and k(x) are the vector versions of {αₜ^{j}} and {k(x,xₜ^{j})}, respectively. For multi-kernel learning, a weighted combination of several kernels may be selected to improve performance, compared to single-kernel learning. A convex combination of kernels {kₚ}ₚ₌₁^{P}, where kₚε [symbol] ₚ is an RKHS, and may be denoted as [symbol] = [symbol] ₁⊕ . . . ⊕ [symbol] ₚ. Using [symbol] instead of [symbol] , the problem may be expressed as

$$\begin{matrix}min \\ \{ {\overline{ω}}_{p}^{j} \} , \{ {f}_{p} \}\end{matrix} {\sum }_{t = 1}^{T} {\sum }_{j = 1}^{J} C ( {\sum }_{p = 1}^{P} {\overline{ω}}_{p}^{j} {f}_{p} ( {x}_{t}^{j} , {y}_{t}^{j} ) ) + λΩ ( {‖ {\sum }_{p = 1}^{P} {\overline{ω}}_{p}^{j} {f}_{p} ‖}_{h}^{2} )$$

$$s . t . {\sum }_{p = 1}^{P} {\overline{ω}}_{p}^{j} = 1 , {\overline{ω}}_{p}^{j} \geq 0 , {f}_{p} ∈ {ℋ}_{p} .$$

A Random Feature (RF) approximation may be used to evade dimensionality. For normalized shift-invariant kernels. Drawing D i.i.d. samples from πₖ(v), a weight vector θ∈ [symbol] ²¹ can be constructed such that \hat{ƒ}(x)=θ^{T}zᵥ(x), where the vector zᵥ(x) will be generated from a pdf πₖ. The loss function may be defined as [symbol] (ƒ(x))= [symbol] (Θ^{T}zᵥ(x),y)+λΩ(∥ν∥²). A weight vector may be constructed and a loss function defined for each Kernel p and Node j:

$${\hat{f}}_{p , t}^{j} ( {x}_{t}^{j} ) = {θ}_{p , t}^{j} , {z}_{{V}_{p}} ( {x}_{t}^{j} ) ,$$

$${θ}_{p , t + 1}^{j} = {θ}_{p , t}^{j} - η ∇ ℒ ( {θ}_{p , t}^{j} , {z}_{{V}_{p}} ( {x}_{t}^{j} ) , {y}_{t}^{j} ) ,$$

$${ω}_{p , t + 1}^{j} = {ω}_{p , t}^{j} exp - ηℒ ( {\hat{f}}_{p , t}^{j} ( {x}_{t}^{j} ) ) ,$$

where n∈(0,1) is a learning rate. The weights may ne normalized as ω_{p,t}^{j}=ω_{p,t}^{j}/Σₚ₌₁^{p}ω_{p,t}^{j} to have

$${\hat{f}}_{t}^{j} ( x ) = {\sum }_{p = 1}^{P} {\overline{ω}}_{p , t}^{j} {\hat{f}}_{p , t}^{j} ( {x}_{t}^{j} ) .$$

The preceding representations represent how local online multi-kernel learning models may be built. According to embodiments, to learn a global model the local models are propagated using a gossip algorithm. The nodes calculate the weighted average of the information provided by their neighbors at each communication round and use it to update their local information. The weights, associated with the existing edges of the graph, are chosen to construct a J×J doubly stochastic gossip matrix. The spectral gap of W′ is denoted by p=1−λ₂(W′)∈(0,1] where λ₂(W′) represents the second eigenvalue of W′ in descending order. A gossip algorithm works very well when the nodes communicate their states perfectly with their neighbors. However, practically, only a few bits can be communicated, i.e., information needs to be quantized before being shared with the neighbors. According to embodiments, a random quantizer Q: [symbol] ⁿ→ [symbol] ⁿ, may be used to represent an arbitrary vector x∈ [symbol] ⁿ, with Q(x) in an efficient way. Embodiments can operate for any random quantizer that satisfies:

$${𝔼}_{Q} {‖ Q ( x ) - x ‖}^{2} \leq ( 1 - δ ) {‖ x ‖}^{2} , {ℝ}^{n} , ∀ x ∈ {ℝ}^{n} .$$

For some δ>0, which may be a compression parameter. Here, [symbol] _{Q} denotes the expected value with respect to the internal randomness of Q(•). Each element of a non-zero vector v∈ [symbol] ⁿ, i.e., vᵢ, may be quantized by Q_{M}(vᵢ)+∥v∥sign(vᵢ)ξᵢ(v,M) where M=2^{b}−1 is the number of quantization levels and defining

$$definingl + ⌊ M \frac{{v}_{i}}{‖ v ‖} ⌋ ,$$

$${ξ}_{i} ( v , M ) = \{ \begin{matrix}\frac{\frac{\frac{1}{M}}{l + 1}}{M} & \begin{matrix}with probability 1 - M \frac{{v}_{i}}{‖ v ‖} + l \\ otherwise\end{matrix} ,\end{matrix}$$

is represented by b bits and

$$δ = 1 - min ( \frac{2 D}{{M}^{2}} , \frac{\sqrt{2 D}}{M} ) > 0.$$

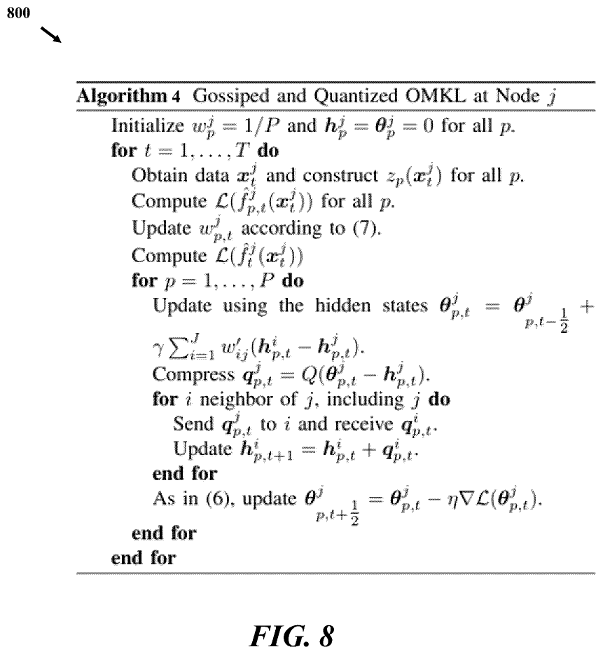

FIG. 8 illustrates a process/algorithm 800 for gossiped and quantized OMKL at a node (e.g., Node j). Systems and processes described herein may use gossiped and quantized OMKL for determining updates to hidden state models. In process 800, at each time instance, nodes collect their local data and transform them according to the RF approximation. Then, the kernel losses are computed and used to update the kernel weights. We define a hidden state h_{p,t}^{j}∈ [symbol] ^{2D} that is the same for all neighbors because it is updated by the same quantized values known to all neighbors. Subsequently, each node j prepares the gossip by quantizing the difference between its local state θ_{p,t}^{j} and the common hidden state h_{p,t}^{j}. This quantized difference is sent to the neighbors and is used by them to collectively update the hidden state. Then, each node performs the gossip/consensus step using the updated hidden states and a step size γ. Finally, each node performs local learning with a step size η. The role of a hidden state and quantized update is to have an accurate representation of the neighbor's states without the need for broadcasting the full state at each time instance.

Process 800 was evaluated experimentally with real data sets for binary classification, with different topologies and using different values of quantization level. The evaluation includes use of Kernel Logistic Regression (KLR) loss function:

$$ln ( 1 + exp ( - y \cdot {θ}^{T} {z}_{V} ( x ) ) ) + λ {‖ θ ‖}^{2} .$$

Experiments were conducted with three datasets: Banana, Credit-Card, and MNIST. The synthetic data from the Banana dataset (n=5300, d=2) are two nonlinearly separable clusters. The Credit-Card dataset (n=30000, d=2) contains data from credit card users, such as their credit history and whether they have defaulted or not, the dataset obtained from the UCI machine learning repository. The MNIST dataset (n=70000, d=784) contains pictures of handwritten digits 0 to 9 and their corresponding labels. For the experiment, datasets are divided into two classes, those that are number 8 and those that are not.

The experimental setup has J=20 nodes, dimension D=20 for our RF approximation, regularization parameter λ=0.001, and three Gaussian kernels with a E {1, 3, 5}. Simulations have been performed 10 times with different sets of Random Features and the corresponding mean is plotted. A quantizer according to embodiments here is used with 7 levels of quantization, that is, 3 bits per element in any transmitted array. Our learning rates are η=0.01 and γ=0.9η=0.009.

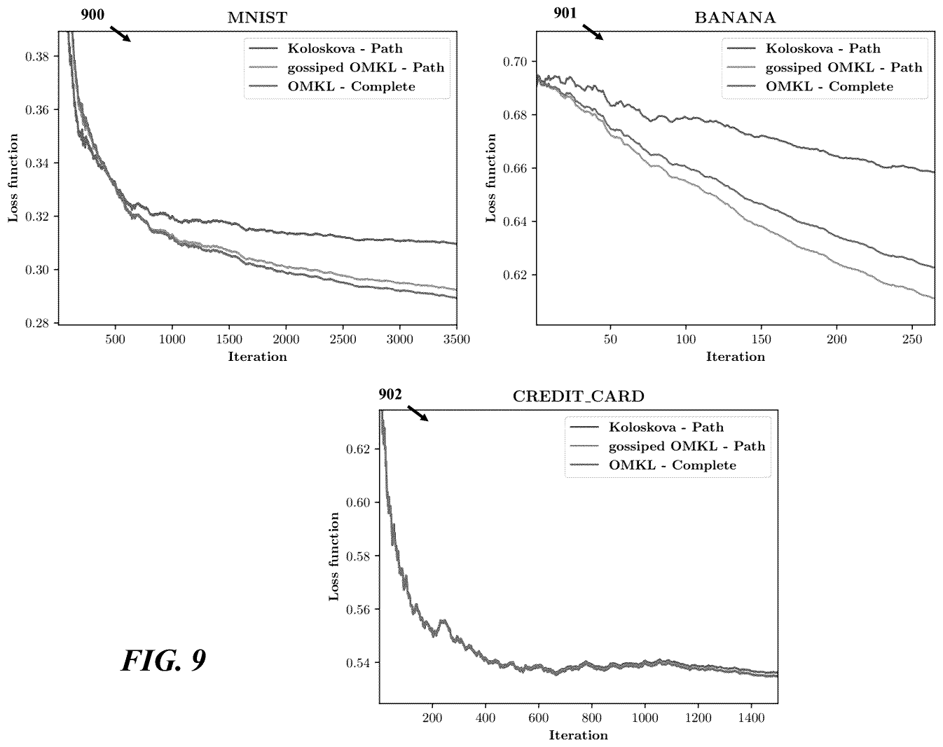

FIG. 9 illustrates a comparison of kernel learning processes according to one or more embodiments. Comparison between the gossiped OMKL, conventional OMKL and a single-kernel SGD, labelled Koloskova includes results 900 for MNIST data, results 901 for Banana, and results 902 for Credit-Card data. In the experiment, a σ=1 is used for the conventional OMKL. The labels indicate the used topology for each algorithm. FIG. 9 compares the performance of our algorithm versus two benchmarks. Since Algorithm 1 can be viewed as an extension to non-complete graphs, the first benchmark for comparison is a conventional OMKL algorithm. In the experiment, there is no significant performance difference between OMKL and gossiped OMKL. This is despite the fact that OMKL is run over a complete topology, but the gossiped OMKL is executed over the worst-case scenario, i.e., a path topology that includes a much smaller number of connections and as a result requires much less communication. Gossiped OMKL can also be considered as an extension to multi-kernel learning, which justifies using the single kernel SGD as a second benchmark. Gossiped OMKL using three kernels clearly outperforms the single kernel approach, named Koloskova in FIG. 9.

Although not shown in the figure, observations from experimental results indicate that, for values of η and γ chosen in FIG. 9, or smaller values, the choice of topology does not affect the performance of our algorithm.

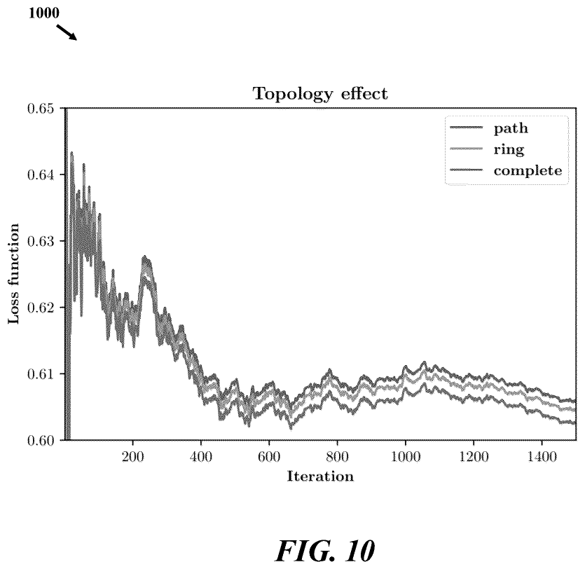

FIG. 10 illustrates a graphical representation of graph topology without quantization according to one or more embodiments. FIG. 10 shows simulations using the Credit-Card dataset and without quantization on three different topologies: the complete graph, the ring, and the path. To observe the effect of topology on algorithm performance, larger step sizes (η=0.1 and γ=0.09) are chosen in FIG. 10 which illustrates effect of graph topology 1000, without quantization for an average loss function at each iteration, with the Credit-Card dataset. Since the Credit-Card dataset has n=30000 data observations, and J=20 nodes, the algorithm is run for 1500 iterations.

Results indicate that more densely connected communication graphs lead to better performance. The algorithm is also tested for M≥7 levels of quantization, that satisfies the condition δ>0 in (11), and all of them perform as well as the non-quantized version, with the loss function differences in the order of 10-6.

The results show that gossiped OMKL algorithm (such as process 800) can successfully extend an OMKL algorithm to non-complete graphs and distributed learning algorithms to multi-kernel learning.

Embodiments are directed to Federated learning, and in particular asynchronous federated learning, which may be faster and more scalable compared to synchronous counterparts. Embodiments can also provide solutions to communications bottlenecks by providing Quantized Asynchronous Federated Learning (QAFeL)), which may be configured to include a hidden-state quantization scheme to avoid error propagation caused by direct quantization. QAFeL may also be provided by a buffer to aggregate client updates, thus ensuring scalability and compatibility with techniques such as secure aggregation. For stochastic gradient descent on non-convex objectives, QAFeL may achieve a ergodic convergence rate. Processes and configurations may be performed without imposing restrictions on the choice of step size, nor assuming uniform client arrivals.

A machine learning pipeline data may collect data for clients in a central server and then train a model on collected data that is deployed for use. General models may have major drawbacks including requiring a large amount of storage at a central server and more importantly privacy concerns may be raised when sensate data is collected. Embodiments may provide decentralized learning, which can deal with privacy concerns. With Federated Learning (FL), clients may train local models and send the local models to a server for aggregation. In FL, local data may be used only to train local models, such that the local data does not leave client devices. By way of example, the clients may send local model updates to a server for aggregation and to update a global model. Inclusion of new updates may improve the global model accuracy. FL may be used for a variety of applications including healthcare, finance, and natural language processing.

FL may have characteristics different from traditional distributed optimization, such as data that originates from clients and that cannot be shared with a server. Second, clients may be heterogeneous (i.e., clients have access to different data sets with different speeds and communication bandwidths). ML models may be large and communicating modes may be costly due to bandwidth.

FIG. 11 illustrates a graphical representation of synchronous and asynchronous federated learning. Some FL models may use synchronous communication schemes, such as communication of updates in rounds. FL learning may include each client performing a stochastic gradient descent (SGD) step with local data and then sending the data to a server. The updated located models may be averaged at the server to create a global model. The global averaged model may be sent back to clients. Updates may be performed in rounds resulting in synchronous FL, where a server may wait a predefined period of time to receive all client updates. When a client misses a time window, an update is considered stale and discarded. For large networks, it may be natural for clients to have different update times. As a result, asynchronous FL, which allows a sever or deice to update a model, such as a global model and local model, respectively, without waiting for all clients. Asynchronous FL may have no idle time and clients may restart calculating updates after each transition. FIG. 11 illustrates synchronous FL 1100 and asynchronous FL 1105. Asynchronous FL may have challenges, such as how to handle stragglers and stale gradients. Asynchronous FL may eliminate the need to fit clients into time slots. As such, slow clients may participate in providing updates for training and larger training cohorts may be used. According to embodiments, processes and devices configurations described herein provide asynchronous FL processes with multiple local steps and limited number of communication bits to avoid error propagation using hidden state updates. Quantization using QAFeL does not affect the complexity order. More precisely, a QAFeL convergence rate may achieve optimal complexity [symbol] (1/\sqrt{T})order for non-convex objectives even without assuming uniform client arrival. In addition, cross-term error caused by staleness and quantization may be of smaller order than errors introduced by each of these factors alone and does not affect complexity order.

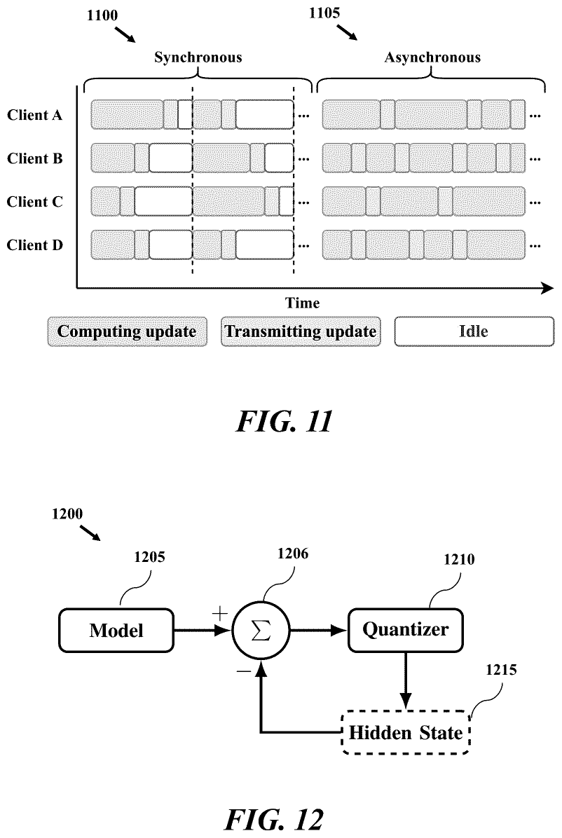

FIG. 12 illustrates a graphical representation of updating a hidden state according to one or more embodiments. According to embodiments, processes and configurations may be performed for asynchronous FL and to include quantization or quantized communication. Apart from allowing multiple local steps, quantization may further reduce communication overhead. Quantization may reduce the data load transmitted in both directions, including sever can quantize a global model before sending to clients and clients can quantize model updates before sending to a server or other clients. Quantizing client updates may also enhance privacy guarantees. Directly quantizing model updates may result in error propagation over time. For example, by only accessing a quantized global model, there may be drift between global models at a server and clients. To manage error propagation, the server and client should operate on a same model. According to embodiments, a common model state 1205 may be defined and kept at nodes. The difference between the updated server model and the common model state may be determined at 1206, may be quantized at 1210 and communicated after every server update. When gossiped protocols are used, updates may be communicated after each client update. Quantized Asynchronous Federated Learning (QAFeL), may include a bidirectional quantization scheme for asynchronous FL with buffered aggregation. To address error propagation, a common hidden state 1215 may be provided according to embodiments and process 1200 illustrates aggregating communicated messages at 1206. According to embodiments, a server (or aggregated client device) may quantize and broadcast the difference between a hidden state and its updated mode. Process 1200 includes model 1205, quantizer 1210, and hidden state 1215. Clients may quantize the difference between an

Process 1200 illustrates Quantized Asynchronous Federated Learning (QAFeL), may include a bidirectional quantization scheme for asynchronous FL with buffered aggregation. To address error propagation, a common hidden state is used by process 1200 by aggregating all communicated messages. According to embodiments, a server device may quantize and broadcast the difference between a hidden state and its updated model. Similarly, clients may quantize the difference between their update model and the corresponding hidden state version. Using process 1200, a QAFeL process is provided that avoids error propagation and is scalable as only the hidden state needs to be tracked. Process 1200 may be a privacy aware system that does not track client states.

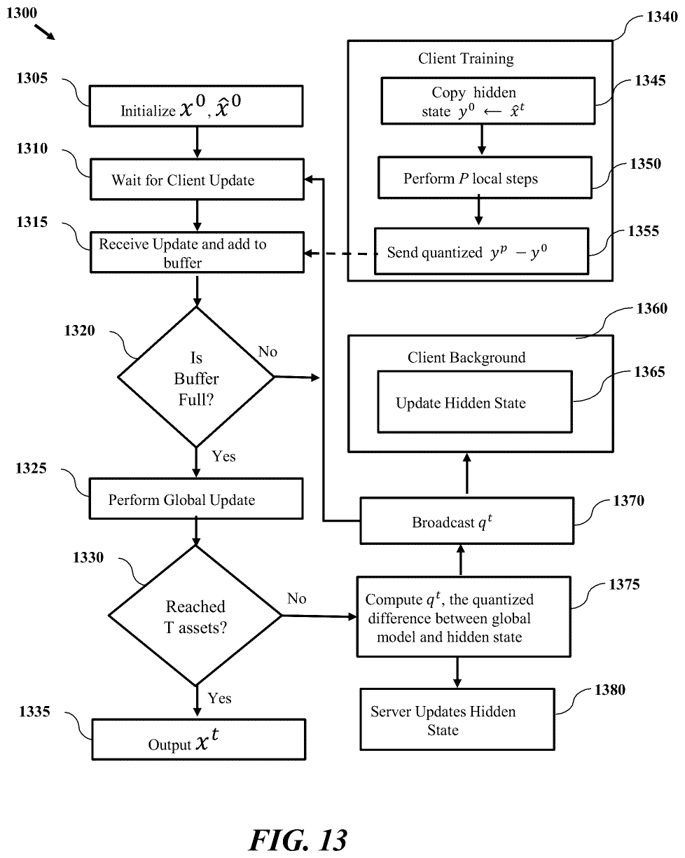

FIG. 13 illustrates a process for quantized communication and learning according to one or more embodiments. According to embodiments, quantization may be provided by a quantizer. A quantizer may include an encoder configured to receive blocks of information and to output blocks of bits, and a decoder which receives clocks of bits and reconstructs blocks of information. If the encoder and the decoder are carefully designed the mean square error between the original and the reconstructed symbols is small, for example smaller than the norm of the original symbols. By way of example, the denoting the combination of the encoder and the decoder may be denoted as a single function Q. A quantizer Q: [symbol] _{d}→ [symbol] ^{d}, (which is a combination of an encoder and a decoder) with a compression parameter δ∈(0,1] is a (possibly random) function that satisfies

$${𝔼}_{q} [ {‖ x - Q ( x ) ‖}^{2} ] \leq ( 1 - δ ) {‖ x ‖}^{2} ,$$

where [symbol] _{q} is the expectation with respect to the possible internal randomness of the quantizer.

According to embodiments, FIG. 13 illustrates processes that may run on one or more of a QAFeL server device, a QAFeL client (e.g., node) device and a QAFeL client background.

According to embodiments, process 1300 may be initiated at block 1305 by at least one client initializing hidden states with \hat{x}⁰, which is the same as the initial server model x⁰. At block 1310, the server waits for a client update. To start training at block 1340, the client copies the locally stored hidden state into a variable y⁰←\hat{x}^{t} at block 1345, and performs P local model update steps of the type

$${y}_{p + 1 = {Y}_{p} - {η}_{l} \cdot g ( {Y}_{p} )}$$

at block 1350, where g(Yₚ) is a noisy, unbiased estimator of the gradient at Yₚ based on the local dataset and ηᵢ is a local step-size. Then, the client sends the quantized update Q_{c}(Y₀−Yₚ₋₁) to the server at block 1355, where Q_{c} is the client's quantizer. The server adds the received updates to its buffer at block 1215. The k-th update in the buffer is denoted as Δₖ. The server keeps receiving updates until the buffer is full (decision block 1320), i.e., the server has received K updates. Then the server updates the global model at block 1325 by averaging the received updates:

$${x}^{t + 1} = {x}^{t} - {η}_{g} {\overline{Δ}}^{t} , {\overline{Δ}}^{t} := \frac{1}{K} {\sum }_{k = 0}^{K - 1} {Δ}_{k} .$$

When the predefined number of iterations T is reached (“Yes” path of decision block 1330), the serve outputs the model and the training stops at block 1335. Otherwise (“No” path of decision block 1330) the server computes the quantized difference between its updated model and the hidden state at block 1375,

$${q}^{t} = {Q}_{s} ( {x}^{t + 1} - {\hat{x}}^{t} )$$

Where Qₛ is the server's quantizer. The server broadcasts q^{t} to all clients at block 1370. The clients, at block 1360 and block 1365, and the server, at block 1380, update their copies of the hidden state using the same equation, \hat{x}^{t+1}=\hat{x}^{t}+q^{t}.

While this disclosure has been particularly shown and described with references to exemplary embodiments thereof, it will be understood by those skilled in the art that various changes in form and details may be made therein without departing from the scope of the claimed embodiments.

What is claimed is:

1. A method for bidirectional quantized communication and buffered aggregation, the method comprising:
sampling, by a server device, at least one client device, wherein the sampling includes a request to update a local model of the client device using a hidden state model;
receiving, by the server device, a quantized difference for the local model of the at least one client device;
aggregating, by the server device, model updates in a buffer;
performing, by the server, a global update on a server model using the model updates in the buffer;
updating, by the server device, the hidden state model using the server model; and
transmitting, by the server device, a hidden state model update to the at least one client device.

2. The method of claim 1, wherein sampling the at least one client device includes a request for local updates to the hidden state model from the at least one client device, and wherein the local updates are determined following training by the at least one client device.

3. The method of claim 1, wherein the server model is a Quantized Federated Learning Model with Buffered Aggregation (QAFeL).

4. The method of claim 1, wherein the quantized difference includes a compressed set of hidden state model updates determined by the at least one client device.

5. The method of claim 1, wherein the quantizer compresses updates to the hidden state model including a function with a compression parameter, and an internal randomness parameter, the function configured to reduce trained dataset updates to a quantized set of data updates.

6. The method of claim 1, wherein aggregating model updates in the buffer includes determining quantized model updates, the quantized model updates providing training feedback for the local model and hidden state model.

7. The method of claim 1, wherein the global update includes updating a server model on the server device based on aggregated training updates received for the hidden state model from at least one client device.

8. The method of claim 1, wherein updating the hidden state model includes modifying a hidden state model using an updated server model on the server device.

9. The method of claim 1, wherein transmitting the hidden state model update includes broadcasting a modified hidden state model to the at least one client device.

10. The method of claim 1, wherein the at least one client device performs a gossiped and quantized communication of hidden state model updates to at least one additional node.

11. A system for bidirectional quantized communication and buffered aggregation, the system comprising:
at least one client device, and
a server device, wherein the server device includes a controller configured to:
sample the at least one client device, wherein sampling includes a request to update a local model of the client device using a hidden state model;
receive a quantized difference for a local model of the at least one client device;
aggregate model updates in a buffer;
perform a global update on a server model using the model updates in the buffer;
update the hidden state model using the server model; and
transmit a hidden state model update to the at least one client device.

12. The system of claim 11, wherein the server model is a Quantized Federated Learning system with Buffered Aggregation (QAFeL).

13. The system of claim 11, wherein the client device includes an unbiased quantizer configured to generate a quantized difference for the local model of the at least one client device and the hidden state model.

14. The system of claim 11, wherein the quantizer compresses updates to the hidden state model including a function with a compression parameter, and an internal randomness parameter, the function configured to reduce trained dataset updates to a quantized set of data updates.

15. The system of claim 11, wherein aggregating model updates in the buffer includes determining quantized model updates, the quantized model updates providing training feedback for the local model and hidden state model.

16. The system of claim 11, wherein the global update includes updating a server model on the server device based on aggregated training updates received for the hidden state model from at least one client device.

17. The system of claim 11, wherein the at least one client device performs a gossiped and quantized communication of hidden state model updates to at least one additional node.

18. A method for bidirectional quantized communication and buffered aggregation, the method comprising:
receiving, by a client device, a hidden state model, the hidden state model based on a server device model;
training, by the client device, a local model to determine updates for the local model;
receiving, by client device, a request to transmit updates determined for the local model of the client device;
generating, by the client device, a quantized difference for the local model and the hidden state model;
transmitting, by the client device, a quantized difference to the server device.

19. The method of claim 18, wherein the model is a Quantized Federated Learning Model with Buffered Aggregation (QAFeL).

20. The method of claim 18, wherein generating a quantized difference is performed by an unbiased quantizer for the client device configured to perform a gossiped and quantized communication of hidden state model updates to at least one additional node.

21. A method for gossiped and quantized communication and learning, the method comprising:
sampling, by a client device, at least one neighboring client device, wherein sampling includes a request for the at least one neighboring client device to update a local model of the at least one neighboring client device using a hidden state model;
receiving, by the client device, a quantized difference for the local model of the at least one neighboring client device;
aggregating, by the client device, model updates in a buffer;
performing, by the client device, a global update on a client model using model updates from the at least one neighboring client device in the buffer; updating, by the client device, the hidden state model of the client device using the client model; and
transmitting, by the client device, a hidden state model update to the at least one neighboring client device, wherein the client device performs a gossiped and quantized communication of hidden state model updates to the at least one neighboring client device.
